(19) United States
(12) Patent Application Publication
(10) Pub. No.: US 2014/0084228 A1
(43) Pub. Date: Mar. 27, 2014

(54) HYDRAULIC LIFTING APPARATUS

(71) Applicant: Harbor Freight Tools USA, Inc., Calabasas, CA (US)

(72) Inventor: Don Briggs Hart, San Clementine, CA (US)

(73) Assignee: Harbor Freight Tools USA, Inc., Calabasas, CA (US)

(21) Appl. No.: 14/033,919

(22) Filed: Sep. 23, 2013

Related U.S. Application Data
(60) Provisional application No. 61/704,063, filed on Sep. 21, 2012.

(51) Int. Cl. B66F 5/04

(52) U.S. Cl. CPC B66F 5/04
USPC 254/2 B

(57) ABSTRACT

Exemplary embodiments of a lifting apparatus having a hydraulic jack for a lawn mower, ATV, or other similar vehicle are provided. A lifting apparatus can have a base portion, a wheel axle bar having a first end and a second end opposite the first end, a lifting apparatus configured to raise the wheel axle bar, a first wheel saddle connected to the first end of the wheel axle bar, a second wheel saddle connected to the second end of the wheel axle bar, and a hydraulic mechanism configured to raise the lifting apparatus. Foot pedal(s) or other mechanisms can be provided to operate the hydraulic jack to raise or lower the vehicle on the lifting apparatus.

### CROSS-REFERENCE TO RELATED APPLICATION(S)

This application relates to and claims priority from U.S. Patent Application Ser. No. 61/704,063 filed Sep. 21, 2012, the entire disclosure of which is hereby incorporated herein by reference.

### FIELD OF THE DISCLOSURE

The present disclosure relates to exemplary embodiments of a hydraulic lifting apparatus, and more particularly, to exemplary embodiments of a hydraulic lifting apparatus for engaging and lifting a small vehicle such as a lawn or garden tractor, all-terrain vehicle (“ATV”) or other similar vehicle.

### BACKGROUND INFORMATION

In recent years, small tractors, riding lawn mowers, ATV's and similar vehicles, have been widely sold for various purposes as the cutting of lawns, tilling the soil, plowing snow, hauling and other similar uses, or for recreational reasons. Like all mechanical equipment, these vehicles require servicing such as the removal of rotary blades for sharpening or replacement, periodic lubrication and/or oil changes, etc. It is mostly inconvenient and expensive to have maintenance performed at a central service facility having the necessary lifts to elevate the vehicle body for performing these operations, since the vehicle must be loaded onto some type of carrier and transported to that facility, and delays in the completion of such servicing are common. Many of these servicing operations are of the type that can be performed by the average owner and indeed many owners would prefer to do this work themselves in order to save time and money, and moreover, insure themselves of satisfactory execution.

However, many maintenance procedures require that at least one end of the tractor or vehicle be elevated at least about one foot and often somewhat higher above the ground so that the operator can have access to the undercarriage of the vehicle where the mower blade is often situated or the lubrication fittings located or other similar device that may need servicing. Despite their relatively small size and capacity, these vehicles nevertheless have a considerable weight which typically exceeds the lifting strength of an average person.

Although conventional jacks of the type used for jacking automobiles and the like could be employed, it is well known by those familiar with automotive mechanics that these jacks are not sufficiently stable in operation to permit work to be safely performed beneath the vehicle suspended therefrom. They must be used together with jack stands. However, because each side of an end of the tractor must be jacked separately and then placed on a separate jack stand for stable elevation, this option is inconvenient and time consuming.

Thus, there is a need for a lifting apparatus for lawn movers, ATV's and similar vehicles that can easily, safely and stably lift the vehicle to a sufficient height to allow a user to perform basic maintenance on the vehicle.

### SUMMARY OF EXEMPLARY EMBODIMENTS OF THE PRESENT DISCLOSURE

At least some of the above described problems can be addressed by exemplary embodiments of the system, method and computer accessible medium according to the present disclosure. For example, using such exemplary embodiments, it is possible to provide a lifting apparatus comprising a base portion, a wheel axle bar having a first end and a second end opposite the first end, a lifting apparatus configured to raise the wheel axle bar, a first wheel saddle connected to the first end of the wheel axle bar, a second wheel saddle connected to the second end of the wheel axle bar, and a hydraulic mechanism configured to raise the lifting apparatus.

The lifting apparatus can comprise a first lower lifting arm connected to the wheel axle bar, and a second lower lifting arm connected to the wheel axle bar. The lifting apparatus can further comprise a first upper lifting arm connected to the wheel axle bar, and a second upper lifting arm connected to the wheel axle bar. The hydraulic mechanism can be supported by the base portion. The hydraulic mechanism can comprise a hydraulic jack.

The lifting apparatus can further comprise a foot pedal configured to operate the hydraulic mechanism to raise the lifting apparatus, and a foot pedal configured to operate the hydraulic mechanism to lower the lifting apparatus. The base portion can comprise a first base bar, a second base bar, and a stabilizer bar connecting the first and second supporting base bars. The lifting apparatus can further comprise a safety plate connected to the lifting mechanism to prevent the lifting mechanism from lowering. The safety plate can have a hole for a pin to prevent the lifting mechanism from lowering.

The lifting apparatus can further comprise a rod connected to an upper portion of the hydraulic mechanism and to the lifting mechanism. The first wheel saddle and second wheel saddle can be adjustable along a length of the wheel axle bar. The lifting apparatus can further comprise a first wheel saddle sleeve in sliding relation to the first end of the wheel axle bar and connected to the first wheel saddle, and a second wheel saddle sleeve in sliding relation to the second end of the wheel axle bar and connected to the second wheel saddle.

The lifting apparatus can further comprise an engagement mechanism for engaging the first wheel saddle sleeve with the first end of the wheel axle bar and for engaging the second wheel saddle sleeve with the second end of the wheel axle bar. The engagement mechanism can comprise a first hole on a top portion of the first end of the wheel axle bar, a second hole on a top portion of the second end of the wheel axle bar, a pin for engagement through a hole on the first wheel saddle sleeve and the first hole, and a pin for engagement through a hole on the second wheel saddle sleeve and the second hole.

The lifting apparatus can further comprise a first rod for selective placement along one or more notches on a first end and a second end of the first wheel saddle providing for an adjustable length of the first wheel saddle, and a second rod for selective placement along one or more notches on a first end and a second end of the second wheel saddle providing for an adjustable length of the second wheel saddle. The lifting apparatus can further comprise a first wheel and a second wheel connected to the base portion. The lifting apparatus can further comprise a first support post connected to the base portion, and a second support post connected to the base portion; wherein the lifting mechanism is connected to the first and second support posts. The first wheel saddle and second wheel saddle can be configured to engage with tires of a vehicle.

Using such exemplary embodiments, it is also possible to provide a lifting apparatus comprising a base portion, a hydraulic jack having an upper portion and a lower portion, the lower portion supported by the base portion, a first lift arm and a second lift arm connected to the upper portion of the hydraulic jack, a wheel axle bar having a first end and a second end opposite the first end, the wheel axle bar being connected to the first lift arm and the second lift arm, a first wheel saddle having a wheel saddle sleeve connected to the first end of the wheel axle bar; and a second wheel saddle having a wheel saddle sleeve connected to the second end of the wheel axle bar, and a foot pedal for operating the hydraulic jack, wherein during operation of the hydraulic jack, the hydraulic jack raises the first lift arm and the second lift arm.

These and other objects, features and advantages of the present disclosure will become apparent upon reading the following detailed description of embodiments of the present disclosure, when taken in conjunction with the appended claims.

### BRIEF DESCRIPTION OF THE DRAWINGS

The foregoing and other objects of the present disclosure will be apparent upon consideration of the following detailed description, taken in conjunction with the accompanying drawings and claims, in which like reference characters refer to like parts throughout, and in which:

FIG. 1 illustrates a perspective view of a lifting apparatus having a hydraulic mechanism according to an exemplary embodiment of the present disclosure;

FIG. 2 illustrates a perspective view of a hydraulic apparatus according to an exemplary embodiment of the present disclosure;

FIG. 3 illustrates a perspective view of a lifting apparatus having lower and upper lift arms connected with a wheel axle sleeve according to an exemplary embodiment of the present disclosure;

FIG. 4 illustrates a perspective view of a lifting apparatus having a wheel axle bar connected with a wheel axle sleeve according to an exemplary embodiment of the present disclosure;

FIG. 5 illustrates a perspective view of a lifting apparatus having wheel saddle sleeves connected to a wheel axle bar according to an exemplary embodiment of the present disclosure;

FIG. 6 illustrates a perspective view of a lifting apparatus having wheel adjusting saddles according to an exemplary embodiment of the present disclosure; and

FIG. 7 illustrates a perspective view of a lifting apparatus having a safety mechanism according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

Exemplary embodiments of a lifting apparatus having a hydraulic jack of the present disclosure will now be described with reference to the figures.

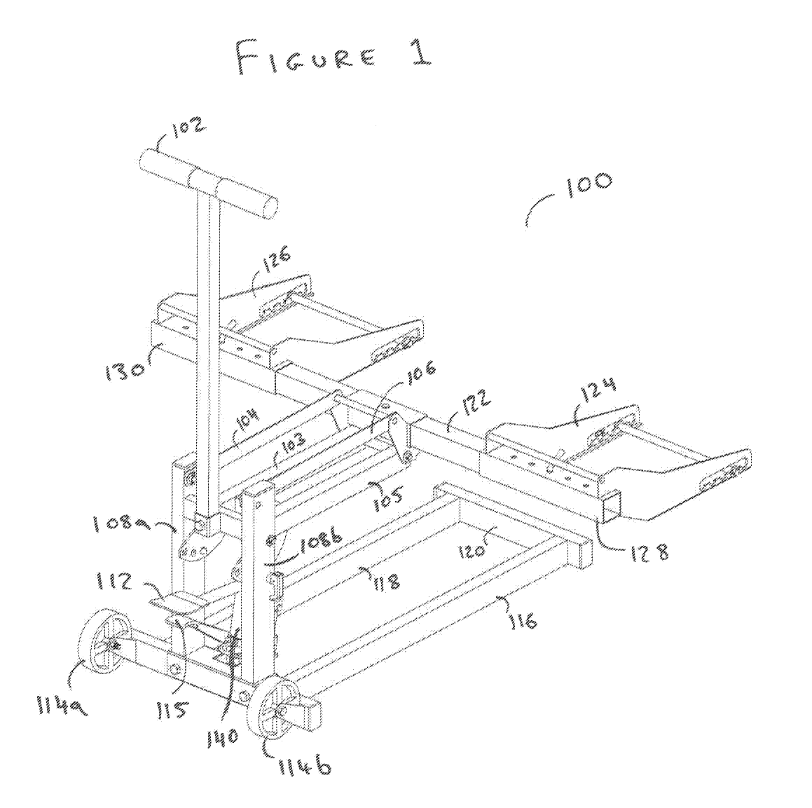

FIG. 1 illustrates a perspective view of a lifting apparatus 100 having a hydraulic mechanism according to an exemplary embodiment of the present disclosure. The lifting apparatus 100 can have a handle 102 and a base portion 150. Wheels 114a and 114b can be provided and attached to the base portion 150. The handle 102 can be removable, and allows guidance of the lifting apparatus 100 when the lifting apparatus 100 is tilted at an angle such that the lifting apparatus 100 rests on the wheels 114a and 114b. The wheels 114 and 114b can be made or rubber, plastic or any other material. The base portion 150 can include a first base bar 116, a second base bar 118, and a stabilizer bar 120 that connects the first base bar 116 and second base bar 118.

A first support post 108a and a second support post 108b can be provided and connected to the base portion 150. A single support post can also be provided instead of first and second support posts. Lower lift arms 103, 105 can be provided and connected to the support posts. A first end of lower lift arm 103 can be connected to the first support post 108a, and a first end of lower lift arm 105 can be connected to the second support post 108b. An opposite end of the lower lift arms 103, 105 can be connected to a wheel axle bar 122.

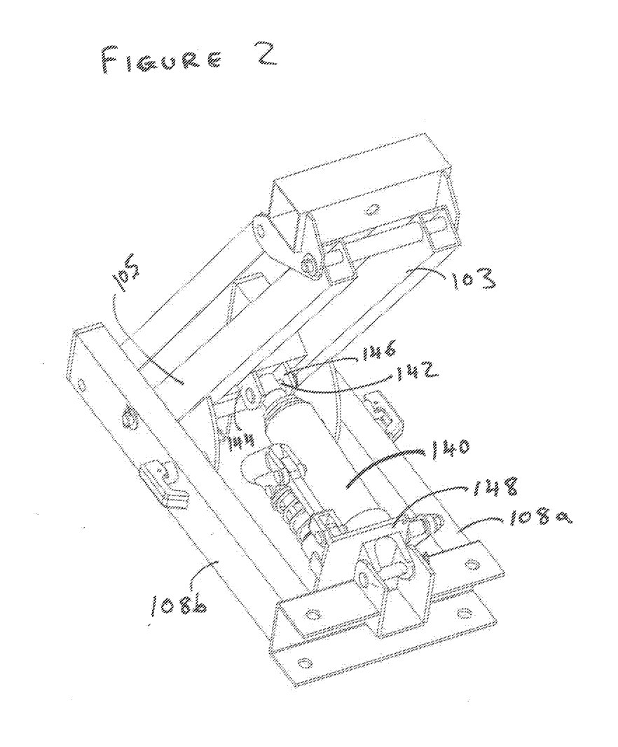

FIG. 2 illustrates a perspective view of a hydraulic apparatus 140 according to an exemplary embodiment of the present disclosure. Lower independent lift arms 103, 105 can be connected to a top portion of a hydraulic apparatus 140, such as a hydraulic jack. For example, in some exemplary embodiments, a rod 142 can be provided on an upper portion of the hydraulic jack 140. The rod 142 can be connected (e.g., by bolts or other mechanism) to plates 142 and 144. The plates can be connected with lower lift arms 103, 105 such that when the hydraulic apparatus is operated, rising of the piston within the hydraulic jack raises the lower lift arms 103, 105. The hydraulic apparatus 140 can be mounted on a base plate 148.

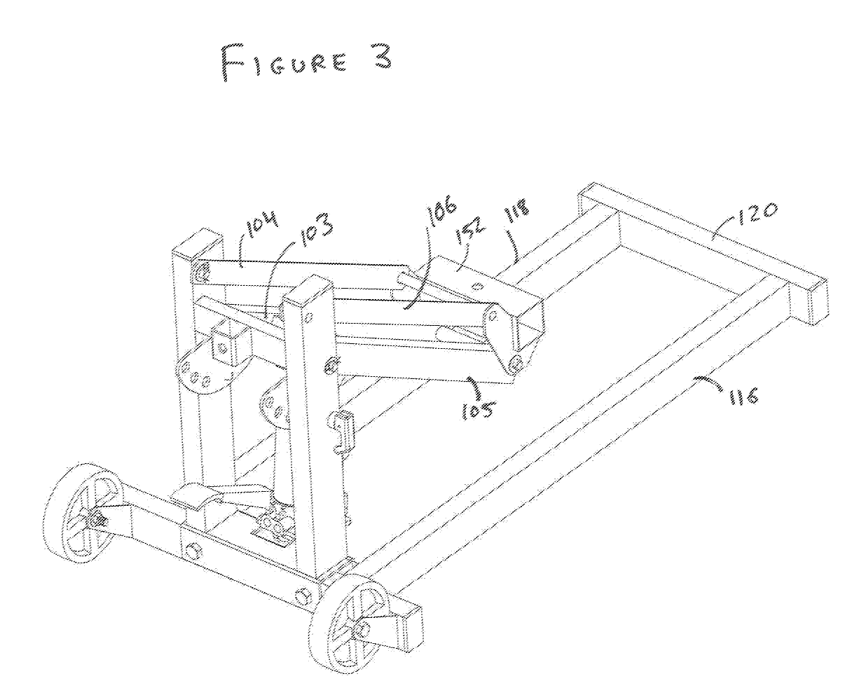

FIG. 3 illustrates a perspective view of a lifting apparatus having lower and upper lift arms connected with a wheel axle sleeve according to an exemplary embodiment of the present disclosure. The lifting apparatus 100 can further have upper lift arms 104, 106 connected to the support posts. A first end of upper lift arm 104 can be connected to the first support post 108a, and a first end of upper lift arm 106 can be connected to the second support post 108b. Opposite ends of the lower lift arms 103, 105 and of the upper lift arms can be connected to a wheel axle sleeve 152. The wheel axle sleeve 152 can have a rectangular or square cross-section and a hollow interior, but is not limited to such a configuration. The upper lift arms 104, 106 can be provided for further stability and support for a vehicle placed on the lifting apparatus 100.

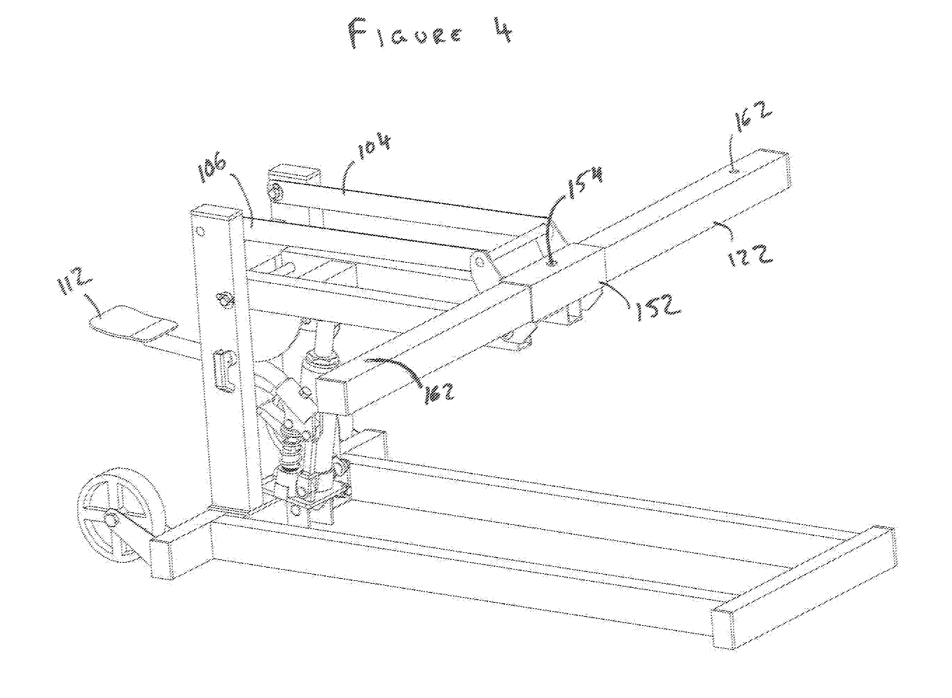

FIG. 4 illustrates a perspective view of a lifting apparatus having a wheel axle bar connected with a wheel axle sleeve according to an exemplary embodiment of the present disclosure. A wheel axle bar 122 having a rectangular or square cross-section and can be inserted within the wheel axle sleeve 152, and can be connected to stay in place (e.g., using bolt 154 or screw or other mechanism). The wheel axle bar 122 can have holes 162 provided on a top surface of opposite ends of the wheel axle bar.

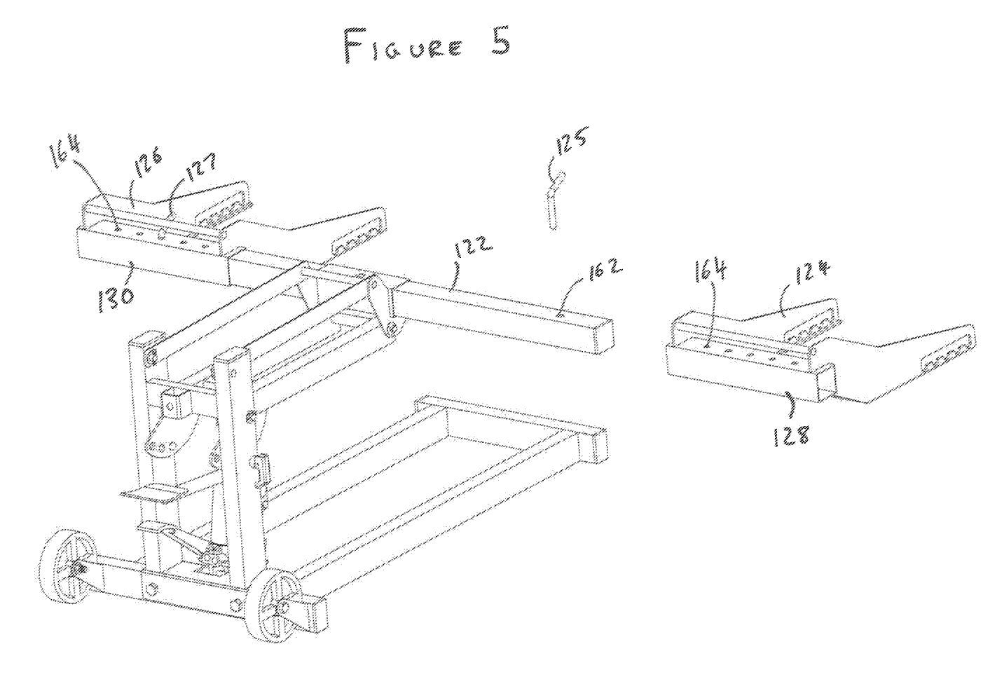

FIG. 5 illustrates a perspective view of a lifting apparatus having wheel saddle sleeves connected to a wheel axle bar according to an exemplary embodiment of the present disclosure. The wheel adjusting saddles 124, 126 can be connected to wheel saddle sleeves 128, 130, respectively. The wheel saddle sleeves 128 and 130 can have a rectangular or square cross-section and a hollow interior, allowing the wheel saddle sleeves 128 and 130 to slide on the wheel axle bar 122. A wheel size adjusting mechanism can be provided where the wheel saddle sleeves 128, 130 can have one or more holes provided on a top portion thereof. The wheel saddle sleeves can be adjusted so that one of the holes 164 corresponds with the hole 162 on the wheel axle bar 122, and pins 125, 127 can be provided through the holes 162, 164 to connect the wheel saddle sleeves 128, 130 to the wheel axle adjusting bar 122. The wheel saddle sleeves 128, 130 are slidable along the axis of the wheel axle adjusting bar 122, and can connect at various positions along the corresponding holes using the pins 125, 127. Different locking and wheel size adjusting mechanisms can be provided, and the foregoing is an exemplary embodiment of such a mechanism. In some exemplary embodiments, the wheel saddle sleeves 128, 130 can be spaced apart at, e.g., five different positions to accommodate various size vehicles (e.g., different lengths between the tires on an axle), and the lifting apparatus 100 is not limited to such number of positions. This allows the lifting apparatus to accommodate vehicles of various sizes as the length between the wheel adjusting saddle 124 and wheel adjusting saddle 126 to vary.

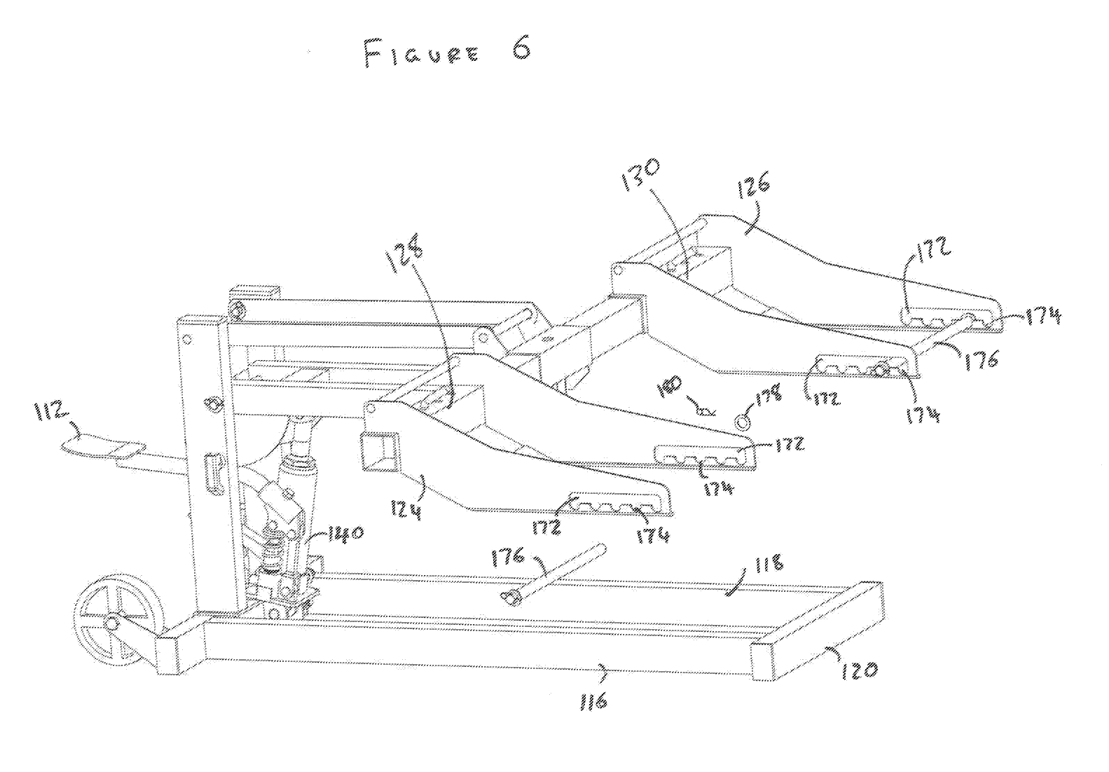

FIG. 6 illustrates a perspective view of a lifting apparatus having wheel adjusting saddles according to an exemplary embodiment of the present disclosure. The wheel adjusting saddles 124, 126 can have cut-out portions 172 on a first and opposite end at an end opposite to where the wheel adjusting saddles 124, 126 are connected to the wheel saddle sleeves 128, 130. The cut-out portions can have one or more notches 174 provided along a length of the cut-out portions 172. A rod 176 can be inserted through the cut-out portions and placed within the notches 174, and locked in place using, e.g., a washer 178 and pin 180. This can allow for various lengths of the wheel adjusting saddles 124, 126 and can provide for, e.g., accommodation of various sizes of tires of different vehicles. Other adjustment mechanisms are also contemplated by the present disclosure, and the present disclosure is not limited to any particular adjustment mechanism.

The hydraulic apparatus 140 can be provided to raise the wheel saddles 124, 126. The hydraulic jack 140 can be operated using foot pedal 112. Depressing the foot pedal 112 can cause the piston within the hydraulic jack 140 to rise, thereby raising the lower lift arms 103, 105 and upper lift arms 104, 106. This raises the wheel axle bar 122 and therefore the wheel saddles 124, 126. The hydraulic jack 140 is not limited by operation to the foot pedal 112. Different mechanisms (e.g., a switch, which can be provided on the handle) can also be used to operate the hydraulic jack 140 to raise or lower the wheel adjusting saddles 124, 126. Supporting base bars 116, 118 can be provided to balance/stabilize the lifting apparatus 100 with or without a load on it, and a stabilizer bar 120 can be provided at a second end of the lifting apparatus 100 to provide further balance/stabilization of the lifting apparatus 100 with or without a load on it. A lowering foot pedal 115 can be provided to operate the hydraulic jack 140 to lower the wheel saddles 124, 126.

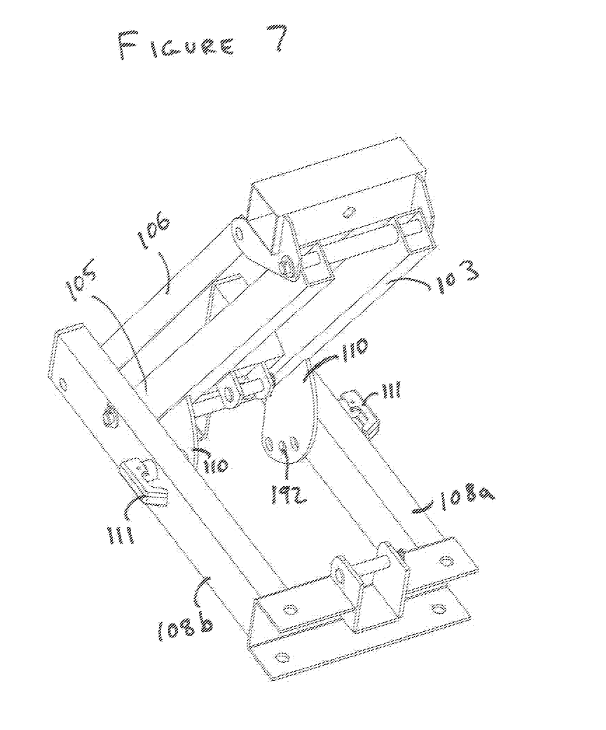

FIG. 7 illustrates a perspective view of a lifting apparatus having a safety mechanism according to an exemplary embodiment of the present disclosure. A safety pin plate 110 can be provided as a precaution in case the hydraulic jack 140 fails during operation of the lifting apparatus 100. A safety plate 110 can be provided along an inner portion of first support post 108a and connected to lower lift arm 103, and a safety plate 110 can be provided along an inner portion of second support post 108b and connected to lower lift arm 105. Holes 192 can be provided with each safety plate 100. When the hydraulic jack is in operation and the wheel saddles 124, 126 are raised, pins 111 can be engaged with a corresponding hole 192 in the safety plates 110. This can provide a safety back-up mechanism in case the hydraulic jack 140 fails so that the user is not injured during maintenance of the vehicle. Other safety mechanisms can be provided instead of a pin to hold the lifting apparatus in a lifted position, and the lifting apparatus is not limited to pins or any type of particular safety device.

Various vehicles and sizes of vehicles can be provided on the lifting apparatus 100. The exemplary embodiments of the lifting apparatus described herein can facilitate and/or provide, e.g., raising a lawn mower, ATV or other similar vehicle for basic maintenance. The lifting apparatus 100 can quickly and easily lift lawn mowers, ATV's and/or other similar four-wheel vehicles. The hydraulic apparatus 140 can provide for lifting of vehicles up to approximately 300 pounds but is not limited to such. For example, one skilled in the art would recognize that different hydraulic jacks can be used to raise vehicles of various weights. Further, the lifting apparatus 100 can be provided to raise vehicles up to 24 inches, or can be provided to raise vehicles up to 36 inches and is not limited to any particular height. One skilled in the art would understand that various parts and materials may be changed or modified in the lifting apparatus 100 to accommodate vehicles of different size/weight. The hydraulic jack 140 is not limited to any particular type of hydraulic jack, and can be a pneumatic jack.

The lifting apparatus 100 can also be folded about the axis of the main support posts 108a and 108b. For example, the lifting apparatus 100 can be lifted from stabilizer bar 120 vertically such that it folds upward, and can be easily moved using wheels 114a, 114b to stow away.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure.

What is claimed is:

1. A lifting apparatus, comprising:
a base portion;
a wheel axle bar having a first end and a second end opposite the first end;
a lifting apparatus configured to raise the wheel axle bar;
a first wheel saddle connected to the first end of the wheel axle bar;
a second wheel saddle connected to the second end of the wheel axle bar; and
a hydraulic mechanism configured to raise the lifting apparatus.

2. The lifting apparatus of claim 1, wherein the lifting apparatus comprises:
a first lower lifting arm connected to the wheel axle bar; and
a second lower lifting arm connected to the wheel axle bar.

3. The lifting apparatus of claim 2, wherein the lifting apparatus further comprises:
a first upper lifting arm connected to the wheel axle bar; and
a second upper lifting arm connected to the wheel axle bar.

4. The lifting apparatus of claim 1, wherein the hydraulic mechanism is supported by the base portion.

5. The lifting apparatus of claim 1, wherein the hydraulic mechanism comprises a hydraulic jack.

6. The lifting apparatus of claim 1, further comprising:
a foot pedal configured to operate the hydraulic mechanism to raise the lifting apparatus.

7. The lifting apparatus of claim 6, further comprising:
a foot pedal configured to operate the hydraulic mechanism to lower the lifting apparatus.

8. The lifting apparatus of claim 1, wherein the base portion comprises:
a first base bar;
a second base bar; and
a stabilizer bar connecting the first and second supporting base bars.

9. The lifting apparatus of claim 1, further comprising:
a safety plate connected to the lifting mechanism to prevent the lifting mechanism from lowering.

10. The lifting apparatus of claim 9, wherein the safety plate has a hole for a pin to prevent the lifting mechanism from lowering.

11. The lifting apparatus of claim 1, further comprising:
a rod connected to an upper portion of the hydraulic mechanism and to the lifting mechanism.

12. The lifting apparatus of claim 1, wherein the first wheel saddle and second wheel saddle are adjustable along a length of the wheel axle bar.

13. The lifting apparatus of claim 1, further comprising:
a first wheel saddle sleeve in sliding relation to the first end of the wheel axle bar and connected to the first wheel saddle; and
a second wheel saddle sleeve in sliding relation to the second end of the wheel axle bar and connected to the second wheel saddle.

14. The lifting apparatus of claim 13, further comprising:
an engagement mechanism for engaging the first wheel saddle sleeve with the first end of the wheel axle bar and for engaging the second wheel saddle sleeve with the second end of the wheel axle bar.

15. The lifting apparatus of claim 14, wherein the engagement mechanism comprises:
a first hole on a top portion of the first end of the wheel axle bar;
a second hole on a top portion of the second end of the wheel axle bar;
a pin for engagement through a hole on the first wheel saddle sleeve and the first hole; and
a pin for engagement through a hole on the second wheel saddle sleeve and the second hole.

16. The lifting apparatus of claim 1, further comprising:
a first rod for selective placement along one or more notches on a first end and a second end of the first wheel saddle providing for an adjustable length of the first wheel saddle; and
a second rod for selective placement along one or more notches on a first end and a second end of the second wheel saddle providing for an adjustable length of the second wheel saddle.

17. The lifting apparatus of claim 1, further comprising:
a first wheel and a second wheel connected to the base portion.

18. The lifting apparatus of claim 1, further comprising:
a first support post connected to the base portion; and
a second support post connected to the base portion; wherein the lifting mechanism is connected to the first and second support posts.

19. The lifting apparatus of claim 1, wherein the first wheel saddle and second wheel saddle are configured to engage with tires of a vehicle.

20. A lifting apparatus, comprising:
a base portion;
a hydraulic jack having an upper portion and a lower portion, the lower portion supported by the base portion;
a first lift arm and a second lift arm connected to the upper portion of the hydraulic jack;
a wheel axle bar having a first end and a second end opposite the first end, the wheel axle bar being connected to the first lift arm and the second lift arm;
a first wheel saddle having a wheel saddle sleeve connected to the first end of the wheel axle bar;
a second wheel saddle having a wheel saddle sleeve connected to the second end of the wheel axle bar; and
a foot pedal for operating the hydraulic jack, wherein during operation of the hydraulic jack, the hydraulic jack raises the first lift arm and the second lift arm.
